(19) United States
(12) Patent Application Publication
(10) Pub. No.: US 2024/0278684 A1
(43) Pub. Date: Aug. 22, 2024

(54) INFORMATION PROCESSING DEVICE, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/428,188

(22) Filed: Jan. 31, 2024

(30) Foreign Application Priority Data
Feb. 22, 2023 (JP) 2023-026023

(51) Int. Cl. B60L 58/12; G06F 8/65

(52) U.S. Cl. CPC B60L 58/12; G06F 8/65; B60L 2270/40

(57) ABSTRACT

An information processing device includes an executing device and a storage device. The executing device is configured to update software stored in the storage device, and control charging electric power to a secondary battery installed in a vehicle. The executing device is configured to, when updating of the software that is not executable at the same time as charging of the secondary battery is requested, perform one of supplying the charging electric power to the secondary battery and updating of the software first, based on urgency information that is information indicating urgency provided with new software to be updated to.

### CROSS-REFERENCE TO RELATED APPLICATION

This application claims priority to Japanese Patent Application No. 2023-026023 filed on Feb. 22, 2023 incorporated herein by reference in its entirety.

### BACKGROUND

### 1. Technical Field

The present disclosure relates to an information processing device, a non-transitory storage medium, and an information processing method.

### 2. Description of Related Art

A mobile terminal described in Japanese Unexamined Patent Application Publication No. 2013-218623 (JP 2013-218623 A) includes an executing device, a storage device, and a secondary battery. The secondary battery supplies electric power to the executing device and the storage device. The executing device acquires software externally from the mobile terminal via wireless communication. The executing device then updates software stored in the storage device with the software that is externally acquired. The executing device also controls charging electric power with which the secondary battery is charged.

### SUMMARY

In the mobile terminals such as in JP 2013-218623 A, requests may be made for software updates that cannot be executed at the same time as charging the secondary battery. On the other hand, depending on the type of software to be updated, for example, a situation may arise in which executing a software update is urgently desired. The mobile terminal in JP 2013-218623 A does not take a situation in which software is updated with priority over charging into consideration whatsoever, and there is room for improvement with regard to this respect.

An information processing device according to a first aspect of the present disclosure includes a storage device and an executing device. The executing device is configured to update software stored in the storage device, and control charging electric power to a secondary battery installed in a vehicle. The executing device is configured to, when updating of the software that is not executable at the same time as charging of the secondary battery is requested, perform one of supplying the charging electric power to the secondary battery and updating of the software first, based on urgency information that is information indicating urgency provided with new software to be updated to.

In the information processing device according to the first aspect of the present disclosure, the urgency information may include a priority level indicating a degree of priority for updating the software. The executing device may be configured to, when updating of the software that is not executable at the same time as charging of the secondary battery is requested, and on condition that the priority level is a level that is to be given priority over a degree of priority that is set in advance, perform updating of the software before supplying the charging electric power to the secondary battery.

In the information processing device according to the first aspect of the present disclosure, the urgency information may include specifying information that specifies whether priority is to be given to updating the software or to supplying the charging electric power to the secondary battery. The executing device may be configured to, when updating of the software that is not executable at the same time as charging of the secondary battery is requested, and on condition that the urgency information includes the specifying information that specifies that updating of the software is to be given priority, perform updating of the software before supplying the charging electric power to the secondary battery.

In the information processing device according to the first aspect of the present disclosure, the executing device may be configured to supply the charging electric power to the secondary battery before updating the software, when updating of the software that is not executable at the same time as charging of the secondary battery is requested, and also a remaining charge of the secondary battery is lower than a stipulated value that is set in advance.

In the information processing device according to the first aspect of the present disclosure, the executing device may be configured to determine which of supplying the charging electric power to the secondary battery and updating of the software is higher in priority, based on the urgency information, and perform the one of the supplying the charging electric power to the secondary battery and updating of the software that is determined to be higher in priority.

According to a second aspect of the present disclosure, a non-transitory storage medium stores instructions that are executable by an information processing device including a storage device and an executing device including one or more processors, and that cause the one or more processors to perform functions. The functions include: updating software stored in the storage device; controlling charging electric power to a secondary battery installed in a vehicle; and when updating of the software that is not executable at the same time as charging of the secondary battery is requested, performing one of supplying the charging electric power to the secondary battery and updating of the software first, based on urgency information that is information indicating urgency provided with new software to be updated to.

According to a third aspect of the present disclosure, an information processing method in an information processing device including an executing device and a storage device, includes: updating software stored in the storage device; controlling charging electric power to a secondary battery installed in a vehicle; and when updating of the software that is not executable at the same time as charging of the secondary battery is requested, performing one of supplying the charging electric power to the secondary battery and updating of the software first, based on urgency information that is information indicating urgency provided with new software to be updated to.

With the above configuration, one of supplying charging electric power to the secondary battery and updating of software can be performed first, in an order suitable for the software, based on urgency information provided with the software.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of an updating system; and

FIG. 2 is a flowchart showing updating and charging control.

### DETAILED DESCRIPTION OF EMBODIMENTS

### Schematic Configuration of Updating System

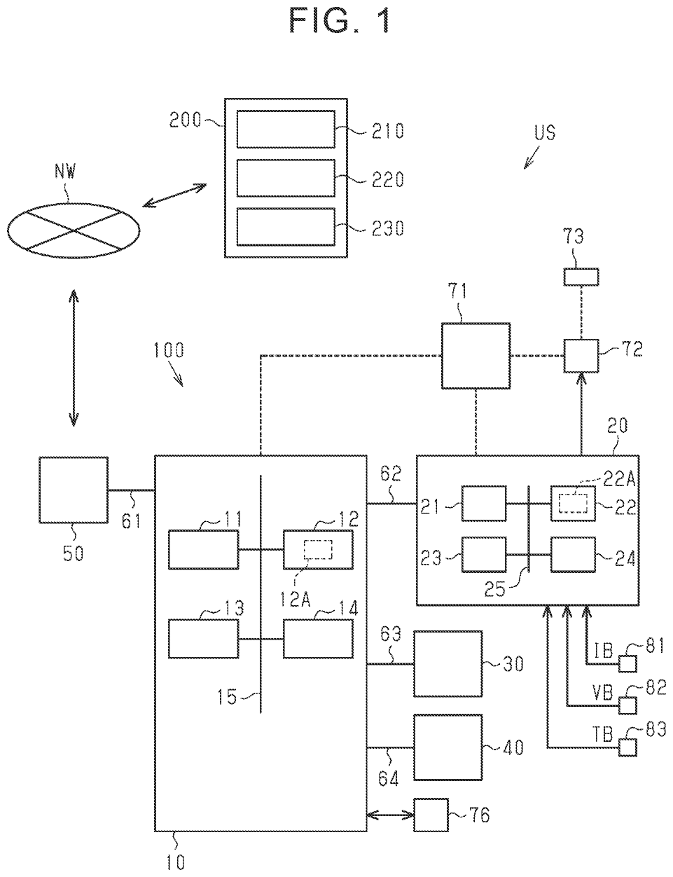

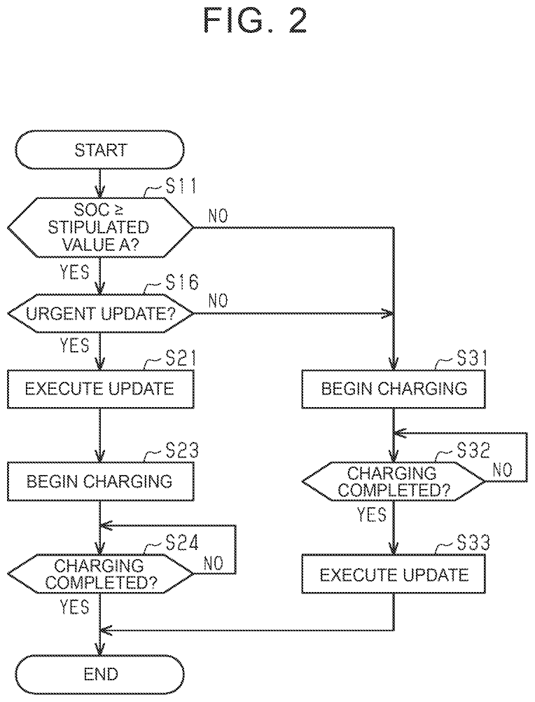

An embodiment of the present disclosure will be described below with reference to FIGS. 1 and 2. First, a schematic configuration of an updating system US will be described.

As illustrated in FIG. 1, the updating system US includes a vehicle 100. An example of vehicle 100 is a so-called battery electric vehicle. The vehicle 100 includes a central ECU 10, a charging ECU 20, a multimedia ECU 30, an advanced driver assistance ECU 40, and a DCM 50. The vehicle 100 also includes a first external bus 61, a second external bus 62, a third external bus 63, and a fourth external bus 64. Note that the term “ECU” is an abbreviation for “electronic control unit”. Also, the term “DCM” is an abbreviation for “data communication module”.

The central ECU 10 centrally controls the overall vehicle 100. The central ECU 10 includes a central processing unit (CPU) 11, read-only memory (ROM) 12, random-access memory (RAM) 13, storage 14, and an internal bus 15. The internal bus 15 connects the CPU 11, the ROM 12, the RAM 13, and the storage 14, so as to be communicable with each other. The ROM 12 stores various types of programs and various types of data in advance. Also, the ROM 12 stores an information processing program 12A, as one of the various types of programs, in advance. The RAM 13 is volatile memory. The RAM 13 temporarily stores various types of programs and various types of data. The CPU 11 uses the RAM 13 as a work area to execute various types of processing by reading programs from the ROM 12. Also, the CPU 11 executes various types of processing in the information processing method by reading the information processing program 12A. In the present embodiment, the CPU 11 is an example of an executing device.

The storage 14 is capable of storing various types of programs and various types of data. The storage 14 is nonvolatile memory that is electrically rewritable. For example, the storage 14 is NAND flash memory. In the present embodiment, the storage 14 may make up part of a storage device.

The DCM 50 is connected to the central ECU 10 via the first external bus 61. The DCM 50 is capable of wireless communication with equipment that is external from the vehicle 100 via a communication network NW. That is, the central ECU 10 is capable of wireless communication with equipment that is external from the vehicle 100 via the first external bus 61 and the DCM 50.

The charging ECU 20 is capable of mutually communicating with the central ECU 10 via the second external bus 62. The charging ECU 20 executes various types of processing related to a secondary battery 71, which will be described later. The charging ECU 20 includes a CPU 21, ROM 22, RAM 23, storage 24, and an internal bus 25. The internal bus 25 connects the CPU 21, the ROM 22, the RAM 23, and the storage 24, so as to be communicable with each other. The ROM 22 stores various types of programs and various types of data in advance. Also, the ROM 22 stores a charging program 22A, as one of the various types of programs, in advance. The ROM 22 is so-called erasable programmable read-only memory (EPROM). That is to say, the charging program 22A stored in the ROM 22 can be updated. The RAM 23 is volatile memory. The RAM 23 temporarily stores various types of programs and various types of data. The CPU 21 uses the RAM 23 as a work area to execute various types of processing by reading programs from the ROM 22. Further, the CPU 21 executes processing related to controlling charging electric power for the secondary battery 71, which will be described later, by reading the charging program 22A. In the present embodiment, the ROM 22 may make up part of a storage device. Accordingly, an information processing device is made up of the central ECU 10 and the charging ECU 20.

The storage 24 is capable of storing various types of programs and various types of data. The storage 24 is nonvolatile memory that is electrically rewritable. For example, the storage 24 is NOR flash memory.

The multimedia ECU 30 is capable of mutually communicating with the central ECU 10 via the third external bus 63. The multimedia ECU 30 controls an automotive navigation system, an audio device, and so forth, which are omitted from illustration. An internal configuration of the multimedia ECU 30 is the same as that of the charging ECU 20. The advanced driver assistance ECU 40 is capable of mutually communicating with the central ECU 10 via the fourth external bus 64. The advanced driver assistance ECU 40 realizes various types of driver assistance by executing various types of applications. Note that the various types of applications include an application for adaptive cruise control, in which the vehicle 100 is followed to a vehicle that travels ahead of the vehicle 100 while maintaining a constant distance thereto, an application for automatically braking the vehicle 100 (automatically decelerating the vehicle 100), and so forth. An internal configuration of the advanced driver assistance ECU 40 is the same as that of the charging ECU 20. Note that the vehicle 100 includes various types of ECUs, such as a powertrain ECU, a body ECU, and so forth, which are omitted from illustration.

As illustrated in FIG. 1, the vehicle 100 includes an equipment group made up of a plurality of pieces of equipment. Examples of such equipment include the secondary battery 71, a converter 72, an inlet 73, and a display 76. The secondary battery 71 supplies electric power to the central ECU 10, the charging ECU 20, the multimedia ECU 30, the advanced driver assistance ECU 40, the DCM 50, and so forth. Note that in FIG. 1, just an electric power path connecting the secondary battery 71 and the central ECU 10, and an electric power path connecting the secondary battery 71 and the charging ECU 20, are representatively illustrated. The inlet 73 is electrically connected to the secondary battery 71 via the converter 72. The inlet 73 is capable of being connected to an external electric power source that is omitted from illustration. The external electric power source supplies alternating current electric power to the inlet 73 on condition that the inlet 73 and the external electric power source are connected. At this time, the converter 72 converts alternating current electric power supplied from the inlet 73 into direct current electric power. As a result, the secondary battery 71 is charged by the electric power supplied from the external electric power source. Note that, as described above, the vehicle 100 is a battery electric vehicle. Accordingly, the external electric power source also supplies electric power to a high-voltage secondary battery that is omitted from illustration, via a high-voltage converter that is omitted from illustration, on condition that the inlet 73 and the external electric power source are connected.

The display 76 is capable of displaying various types of information. Also, the display 76 is a so-called touch panel display. Accordingly, the user of the vehicle 100 can input various types of information via the display 76. That is to say, the display 76 functions both as output equipment that outputs information to the user, and as input equipment that accepts information from the user.

As illustrated in FIG. 1, the vehicle 100 includes a sensor group made up of a plurality of sensors. Examples of these sensors include a current sensor 81, a voltage sensor 82, and a temperature sensor 83. The current sensor 81 detects a current IB input to and output from the secondary battery 71. The voltage sensor 82 detects a voltage VB that is voltage between terminals of the secondary battery 71. The temperature sensor 83 detects a battery temperature TB that is the temperature of the secondary battery 71.

The charging ECU 20 acquires corresponding signals from the current sensor 81, the voltage sensor 82, and the temperature sensor 83, respectively. Also, the charging ECU 20 calculates a state of charge (SOC) of the secondary battery 71 based on the current IB, the voltage VB, and the battery temperature TB, at each control cycle set in advance. In the present embodiment, the SOC is an example of remaining charge in the secondary battery 71. The SOC is expressed by the following Expression (1).

SOC (%)=remaining capacity (Ah) of secondary battery 71/full-charge capacity (Ah) of secondary battery 71×100 (%) Expression (1):

In the above Expression (1), the full-charge capacity is the greatest amount of electric power that the secondary battery 71 can store. The full-charge capacity varies somewhat depending on the history of the voltage VB and the current IB of the secondary battery 71, and the battery temperature TB thereof. Accordingly, the full-charge capacity is calculated based on history of the voltage VB and the current IB of the secondary battery 71, and the battery temperature TB thereof. Also, the remaining capacity is calculated based on, for example, integrated values of the current IB and the voltage VB after the secondary battery 71 is fully charged.

The charging ECU 20 controls the converter 72 by outputting a control signal to the converter 72. Accordingly, the charging ECU 20 can control charging electric power to the secondary battery 71 through control of the converter 72, on condition that the inlet 73 and the external electric power source are connected.

The central ECU 10 displays various types of information on the display 76 by outputting control signals to the display 76. Also, the central ECU 10 acquires, from the display 76, information input by the user of the vehicle 100.

As illustrated in FIG. 1, the updating system US includes a data center 200. An example the data center 200 is a so-called server. The data center 200 includes an executing unit 210, a storage unit 220, and a communication unit 230. The communication unit 230 is capable of communicating with equipment that is external from the data center 200 via the communication network NW. The storage unit 220 stores information acquired by the data center 200, and so forth. The storage unit 220 also stores various types of programs in advance. The executing unit 210 executes various types of processing by reading the programs in the storage unit 220. Note that an example of the executing unit 210 is a CPU.

### Updating and Charging Control

Next, updating and charging control executed by the central ECU 10 will be described with reference to FIG. 2. The CPU 11 of the central ECU 10 executes the updating and charging control when there is a request to charge the secondary battery 71, and a request to update software that cannot be executed at the same time as charging the secondary battery 71. Here, an example of when there is a request to charge the secondary battery 71 is when the inlet 73 is connected to an external electric power source. Also, an example of when there is a request for a software update is when all of the following requirements (1) and (2) are satisfied.
Requirement (1): The central ECU 10 has received a campaign notification, indicating the existence of new software, from the data center 200.
Requirement (2): After the campaign notification is received, new software to be updated to is downloaded from the data center 200, and thereby the new software is stored in the storage 14 of the central ECU 10.

Also, an example of software regarding which software update cannot be executed at the same time as charging the secondary battery 71 is the charging program 22A. Note that the CPU 11 of the central ECU 10 receives urgency information IU along with a campaign notification indicating the existence of new software, from the data center 200. Now, the urgency information IU is information indicating urgency, which is provided with the new software to be updated to. In the present embodiment, the CPU 11 of the central ECU 10 executes the updating and charging control by reading the information processing program 12A.

As shown in FIG. 2, upon beginning the updating and charging control, the CPU 11 of the central ECU 10 executes the processing of step S11. In step S11, the CPU 11 determines whether the SOC of the secondary battery 71 is more than or equal to a stipulated value A that is set in advance. Here, the stipulated value A is a threshold value for determining whether the SOC is sufficient to update the software before the secondary battery 71 is supplied with charging electric power. An example of the stipulated value A is 20%. In step S11, when the CPU 11 determines that the SOC of the secondary battery 71 is more than or equal to the stipulated value A (YES in S11), the CPU 11 advances the processing to step S16.

In step S16, the CPU 11 determines whether the need for the software to be updated is urgent, based on the urgency information IU. Specifically, the CPU 11 determines whether the need for the software to be updated is urgent, based on a priority level LP included in the urgency information IU, and a stipulated priority Z, which is a degree of priority that is set in advance. Here, the priority level LP indicates the degree of priority that should be given regarding updating of new software to be updated to. Examples of the priority level LP include numerical values such as “1”, “2”, “3”, and “4”. Note that in the present embodiment, the larger the numerical value of the priority level LP is, the higher the degree is regarding which software updating should be prioritized. Also, the lower the SOC of the secondary battery 71 is at the point in time of the processing in step S16, the greater a numerical value the CPU 11 sets the stipulated priority Z to. Examples of the stipulated priority Z include numerical values such as “1”, “2”, and “3”. Note that the stipulated priority Z is set to be smaller than the greatest numerical value of the priority level LP. Accordingly, in the present embodiment, the CPU 11 determines that the need to update the software is urgent when the numerical value of the priority level LP is higher than the numerical value of the stipulated priority Z, i.e., when the priority level LP is a level that should be given priority over the stipulated priority Z. On the other hand, the CPU 11 determines that the need to update the software is not urgent when the numerical value of the priority level LP is no higher than the numerical value of the stipulated priority Z, i.e., when the priority level LP is a level that should be given priority no more than the stipulated priority Z (charging should be prioritized over software updates).

In step S16, when the CPU 11 determines that the need to update the software is urgent (YES in S16), the CPU 11 advances the processing to step S21. That is to say, the CPU 11 advances the processing to step S21 when a software update, that cannot be executed at the same time as charging the secondary battery 71, is requested, and on condition that the priority level LP is a level that should be prioritized over the stipulated priority Z.

In step S21, the CPU 11 executes updating of the software stored in the ROM 22. Specifically, the CPU 11 first places the charging ECU 20 in an off state. Further, the CPU 11 installs the new charging program 22A stored in the storage 14 into the ROM 22 of the charging ECU 20. The CPU 11 then activates the charging program 22A that is installed. Thereafter, the CPU 11 places the charging ECU 20 in an on state. Following step S21, the CPU 11 advances the processing to step S23.

In step S23, the CPU 11 begins supplying charging electric power to the secondary battery 71. Specifically, the CPU 11 outputs a control signal to the charging ECU 20. As a result, the charging ECU 20 begins supply of the charging electric power to the secondary battery 71. Following step S23, the CPU 11 advances the processing to step S24.

In step S24, the CPU 11 determines whether supplying of the charging electric power to the secondary battery 71 has been completed. For example, when the SOC of the secondary battery 71 is more than or equal to a reference value B that is set in advance, the CPU 11 determines that supplying of the charging electric power to the secondary battery 71 is completed. Here, the reference value B is a threshold value for determining whether the SOC of the secondary battery 71 has become sufficiently high. In the present embodiment, an example of the reference value B is 100%. In step S24, when the CPU 11 determines that supplying of the charging electric power to the secondary battery 71 is not completed (NO in S24), the CPU 11 advances the processing to step S24 again. On the other hand, when the CPU 11 determines in step S24 that supplying of the charging electric power to the secondary battery 71 is completed (YES in S24), the CPU 11 ends the current updating and charging control. Thus, in the processing of steps S21 to S24, the software is updated before charging electric power is supplied to the secondary battery 71.

On the other hand, in the above-described step S11, when the CPU 11 determines that the SOC of the secondary battery 71 is lower than the stipulated value A (NO in S11), the CPU 11 advances the processing to step S31. That is to say, when a software update, that cannot be executed at the same time as charging the secondary battery 71, is requested, and also the SOC of the secondary battery 71 is lower than the stipulated value A, the CPU 11 advances the processing to step S31.

Also, in the above-described step S16, when the CPU 11 determines that the need to update the software is not urgent (NO in S16), the CPU 11 advances the processing to step S31.

In step S31, the CPU 11 begins supplying the charging electric power to the secondary battery 71. Note that the processing in step S31 is the same as the processing in step S23 described above. Following step S31, the CPU 11 advances the processing to step S32.

In step S32, the CPU 11 determines whether supplying of the charging electric power to the secondary battery 71 has been completed. Note that the processing in step S32 is the same as the processing in step S24 described above. That is to say, in step S32, when the CPU 11 determines that supplying of the charging electric power to the secondary battery 71 is not completed (NO in S32), the CPU 11 advances the processing to step S32 again. On the other hand, when the CPU 11 determines in step S32 that supplying of the charging electric power to the secondary battery 71 is completed (YES in S32), the CPU 11 advances the processing to step S33. The reference value B in step S32 may be different from the reference value B in step S24. For example, the reference value B in step S32 may be the same as the stipulated value A.

In step S33, the CPU 11 executes updating of the software stored in the ROM 22. Note that the processing in step S33 is the same as the processing in step S21 described above. Following step S33, the CPU 11 ends the current updating and charging control. Thus, in the processing of steps S31 to S33, the charging electric power is supplied to the secondary battery 71 before updating of the software is performed.

### Operations of Present Embodiment

An assumption will be made that in the vehicle 100, a request is made to charge the secondary battery 71, and also a request is made for a software update that cannot be executed at the same time as charging the secondary battery 71. In this case, as shown in FIG. 2, the CPU 11 of the central ECU 10 executes the updating and charging control. In step S16, the CPU 11 of the central ECU 10 determines whether the need for the software to be updated is urgent, based on the urgency information IU provided with the new software to be updated to. Now, when the priority level LP included in the urgency information IU is a level that should be given priority over the stipulated priority Z, for example, the CPU 11 of the central ECU 10 executes the processing of steps S21 to S24. That is to say, the CPU 11 of the central ECU 10 updates the software before supplying the charging electric power to the secondary battery 71. On the other hand, when the priority level LP included in the urgency information IU is a level of priority no higher than the stipulated priority Z, for example, the CPU 11 of the central ECU 10 executes the processing of steps S31 to S33. That is to say, the CPU 11 of the central ECU 10 supplies the charging electric power to the secondary battery 71 before updating the software.

### Effects of Present Embodiment

(1) As described above, the CPU 11 of the central ECU 10 performs one of supplying charging electric power to the secondary battery 71 and updating of the software first, based on the urgency information IU provided with the new software to be updated to. Therefore, one of supplying the charging electric power to the secondary battery 71 and updating the software can be performed first, in an order that is appropriate with respect to the urgency of the new software to be updated to.

(2) In the present embodiment, the urgency information IU includes the priority level LP indicating the degree of priority regarding the new software to be updated to. Also, in step S16, the CPU 11 of the central ECU 10 advances the processing to step S21 on condition that the priority level LP is a level that should be given priority over the stipulated priority Z. That is to say, the CPU 11 of the central ECU 10 updates the software before supplying the charging electric power to the secondary battery 71. Thus, the software can be updated before the charging electric power is supplied to the secondary battery 71, with consideration for the degree of priority that should be given to updating regarding the new software to be updated to.

(3) In step S16, the lower the SOC of the secondary battery 71 is at the point in time of processing in step S16, the greater the numerical value is that the CPU 11 of the central ECU 10 sets the stipulated priority Z to. When the numerical value of the priority level LP is less than or equal to the numerical value of the stipulated priority Z, i.e., when the priority level LP is a level that should be prioritized less than or equal to the stipulated priority Z, the CPU 11 advances the processing to step S31. Accordingly, the lower the SOC of the secondary battery 71 is at the point in time of processing in step S16, the easier it is for the processing is to advance to step S31. Thus, in a situation in which priority should be given to supplying the charging electric power to the secondary battery 71, the charging electric power can be supplied to the secondary battery 71 before updating the software.

(4) In step S11, when a software update that cannot be executed at the same time as charging the secondary battery 71 is requested, and also the SOC of the secondary battery 71 is lower than the stipulated value A, the CPU 11 of the central ECU 10 advances the processing to step S31. That is to say, the CPU 11 of the central ECU 10 supplies the charging electric power to the secondary battery 71 before updating the software. Thus, in a situation in which the SOC of the secondary battery 71 is lower than the stipulated value A, i.e., the SOC of the secondary battery 71 is relatively low, the charging electric power is supplied to the secondary battery 71 before updating the software. As a result, depletion of the SOC of the secondary battery 71 can be suppressed.

### MODIFICATIONS

The present embodiment can be carried out modified as follows. The present embodiment and the following modifications can be combined with each other and carried out as long as no technical contradiction arises.
In the above embodiment, the updating and charging control may be changed.
For example, the processing of step S11 may be omitted. As a specific example, the CPU 11 of the central ECU 10 may execute the processing of step S16 when the updating and charging control is begun. Note that even when the processing of step S11 is omitted, the likelihood of the SOC of the secondary battery 71 dropping excessively is small, and accordingly effects thereof are slight.
For example, in step S16, the way in which determination is made regarding whether the need for the software to be updated is urgent may be changed. As a specific example, a constant numerical value that is set in advance may be adopted as the stipulated priority Z, regardless of the SOC of the secondary battery 71 at the point in time of processing in step S16.

Also, as a specific example, the urgency information IU may include, instead of the priority level LP, specifying information that specifies whether priority should be given to updating the software or to supplying the charging electric power to the secondary battery 71. In this case, the CPU 11 of the central ECU 10 may determine that the need for the software update is urgent when the urgency information IU includes the specifying information specifying that the software update should be prioritized. In other words, the CPU 11 of the central ECU 10 performs updating of the software before supplying the charging electric power to the secondary battery 71 when receiving a request for updating software that cannot be executed at the same time as charging the secondary battery 71, and on condition that the urgency information IU includes specifying information specifying that the software update should be prioritized. Thus, the software can be updated before the charging electric power is supplied to the secondary battery 71, with consideration for the specifying information that is set in advance, along with the new software that is to be updated to.

Further, as a specific example, the urgency information IU may include type information indicating the type of new software to be updated to, instead of the priority level LP. In this case, the CPU 11 of the central ECU 10 may determine that the need for the software to be updated is urgent when the type information indicates a specific software type that is set in advance. Thus, the software can be updated before the charging electric power is supplied to the secondary battery 71, with consideration for the type of new software to be updated to. Note that an example of the specific software is software related to security of the charging ECU 20.
For example, the processing contents of step S21 may be changed. As a specific example, in step S21, the CPU 11 of the central ECU 10 may store the new charging program 22A in the storage 14 by downloading the new charging program 22A from the data center 200. That is to say, in the above configuration, the storage 14 does not need to store the new charging program 22A at the point in time of beginning the processing in step S21. Note that in this case, the conditions for executing the updating and charging control may also be changed. Also, the processing contents of step S33 can be changed, in the same way as in step S21.
In the above embodiment, the configuration of the updating system US may be changed. For example, the ECU that executes the updating and charging control is not limited to the central ECU 10. As a specific example, the CPU of the multimedia ECU 30 may execute updating and charging control by reading the information processing program 12A stored in ROM of the multimedia ECU 30, instead of the central ECU 10. In this case, the information processing device is made up of the multimedia ECU 30 and the charging ECU 20. That is to say, ECUs such as the central ECU 10, the charging ECU 20, the multimedia ECU 30, the advanced driver assistance ECU 40, and so forth, can be adopted as the information processing device.
For example, the secondary battery installed in the vehicle 100 is not limited to the secondary battery 71. As a specific example, the above high-voltage secondary battery that the vehicle 100 is equipped with can be adopted as the secondary battery installed in the vehicle 100.

What is claimed is:

1. An information processing device, comprising:
a storage device; and
an executing device configured to
update software stored in the storage device,
control charging electric power to a secondary battery installed in a vehicle, and
when updating of the software that is not executable at the same time as charging of the secondary battery is requested, perform one of supplying the charging electric power to the secondary battery and updating of the software first, based on urgency information that is information indicating urgency provided with new software to be updated to.

2. The information processing device according to claim 1, wherein:
the urgency information includes a priority level indicating a degree of priority for updating the software; and
the executing device is configured to, when updating of the software that is not executable at the same time as charging of the secondary battery is requested, and on condition that the priority level is a level that is to be given priority over a degree of priority that is set in advance, perform updating of the software before supplying the charging electric power to the secondary battery.

3. The information processing device according to claim 1, wherein:
the urgency information includes specifying information that specifies whether priority is to be given to updating the software or to supplying the charging electric power to the secondary battery; and
the executing device is configured to, when updating of the software that is not executable at the same time as charging of the secondary battery is requested, and on condition that the urgency information includes the specifying information that specifies that updating of the software is to be given priority, perform updating of the software before supplying the charging electric power to the secondary battery.

4. The information processing device according to claim 1, wherein the executing device is configured to supply the charging electric power to the secondary battery before updating the software, when updating of the software that is not executable at the same time as charging of the secondary battery is requested, and also a remaining charge of the secondary battery is lower than a stipulated value that is set in advance.

5. The information processing device according to claim 1, wherein the executing device is configured to
determine which of supplying the charging electric power to the secondary battery and updating of the software is higher in priority, based on the urgency information, and
perform the one of the supplying the charging electric power to the secondary battery and updating of the software that is determined to be higher in priority.

6. A non-transitory storage medium storing instructions that are executable by an information processing device including a storage device and an executing device including one or more processors, and that cause the one or more processors to perform functions comprising:
updating software stored in the storage device;
controlling charging electric power to a secondary battery installed in a vehicle; and
when updating of the software that is not executable at the same time as charging of the secondary battery is requested, performing one of supplying the charging electric power to the secondary battery and updating of the software first, based on urgency information that is information indicating urgency provided with new software to be updated to.

7. An information processing method in an information processing device including an executing device and a storage device, the information processing method comprising:
updating software stored in the storage device;
controlling charging electric power to a secondary battery installed in a vehicle; and
when updating of the software that is not executable at the same time as charging of the secondary battery is requested, performing one of supplying the charging electric power to the secondary battery and updating of the software first, based on urgency information that is information indicating urgency provided with new software to be updated to.
